(19) United States
(12) Patent Application Publication
(10) Pub. No.: US 2021/0289738 A1
(43) Pub. Date: Sep. 23, 2021

(54) Automated Cow Teat Sprayer

(71) Applicant: Abram Josiah Higley, Jerome, ID (US)

(72) Inventor: Abram Josiah Higley, Jerome, ID (US)

(21) Appl. No.: 17/210,372

(22) Filed: Mar. 23, 2021

Related U.S. Application Data
(60) Provisional application No. 62/993,553, filed on Mar. 23, 2020.

(51) Int. Cl. A01J 7/04; A01K 1/12; A01K 29/00

(52) U.S. Cl. CPC A01J 7/04; A01K 29/005; A01K 1/12

(57) ABSTRACT

An automated cow teat spray is an apparatus that includes a plurality of lasers, a control assembly, a spray unit, and a solenoid unit.

The current application claims a priority to the U.S. Provisional Patent application Ser. No. 62/993,553 filed on Mar. 23, 2020.

### FIELD OF THE INVENTION

The present invention generally relates to dairy farming. More specifically, the present invention relates to a system for disinfecting and cleaning a dairy cow's teats prior to and after milking.

### BACKGROUND OF THE INVENTION

An effective system for cleaning cow teats is in demand. The practice of washing/disinfecting a dairy cow's teats to remove any dirt, hay, mud, or other material before milking is a common practice. In fact, the cleaning of the teats and udder is an extremely important operation in cow-milking systems. Before attaching milking machines to cows to be milked, the teats are sprayed or dipped using iodine, peroxide, or various other chemicals (“pre-dip”). The purpose is to disinfect and clean the teat prior to milking. Immediately after milking, another chemical is applied to disinfect again to prevent the spread of disease and to condition the end of the teat for the purpose of protection (“post-dip”).

Historically, this cleansing of the teats has been a labor-intensive process because it requires a farm worker to apply cleaning chemicals to each cow individually. However, as technology advances, various cleaning devices have been designed to facilitate teat washing prior to milking. Conventional systems employ spray nozzles, cups, or rotational brushes positioned underneath the cow's udder. While a robotic system can be used to perform this operation, an operator typically needs to manually hold these rotary brush devices during the washing process and move the cleaning device from one teat to another and from one cow to another. Accordingly, this process involves the time-consuming positioning of the device.

Other systems solve the sanitation problem by using teat cups. One device includes spray nozzles to spray the teat with washing liquid prior to engaging the cup onto the teat for milking. Another device includes a flexible interior wall that massages the teat as washing liquid is sprayed onto the teat. In addition, some devices use a camera to identify the position of the cow. However, in general, these devices using teat cups are integrated into robotic milking operations that have inaccurate cameras, require a stationary cow, and consequently identifying the precise position of the cow to facilitate thoroughly cleaning the udder is a problem.

Thus, there is a need to develop a device that provides convenient and accurate positioning of a cleaning application to allow a thorough teat-washing operation that removes as much contamination as possible prior to milking. Ideally, there is a need for a device that does not interrupt cow flow and can apply chemical while the cow is in motion.

The present invention is intended to address problems associated with and/or otherwise improve on conventional devices through an innovative cleaning device that is designed to provide a convenient means of identifying the position of the cow while incorporating other problem-solving features.

### BRIEF DESCRIPTION OF THE DRAWINGS

FIG. 1 is an illustration showing one embodiment of the present invention.

FIG. 2 is an illustration showing one embodiment of the present invention with a human-machine interface (HMI).

FIG. 3 is an illustration showing one embodiment of the present invention with a spray unit installed on the ground.

FIG. 4 is an illustration showing one embodiment of the present invention with a control assembly attached on a milking parlor.

FIG. 5 is an illustration showing an improved embodiment of the present invention.

FIG. 6 is another illustration showing an improved embodiment of the present invention.

FIG. 7 is another illustration showing an improved embodiment of the present invention.

### DETAILED DESCRIPTION OF THE INVENTION

All illustrations of the drawings are for the purpose of describing selected versions of the present invention and are not intended to limit the scope of the present invention.

The present invention provides accurate tracking of a cow moving into a milking parlor (“chute”) by using photoelectric sensors or lasers as she walks over a spray unit containing several spray nozzles that are anchored to the ground. The device is anchored to the surface, unobtrusive to cow flow, and can be retrofitted into any barn. When the cow's position is detected by the lasers, the system sends a signal to a control assembly (e.g., a programmable logic controller [PLC]) to activate multiple solenoids controlling air and chemicals to allow the system to spray the cow's teats.

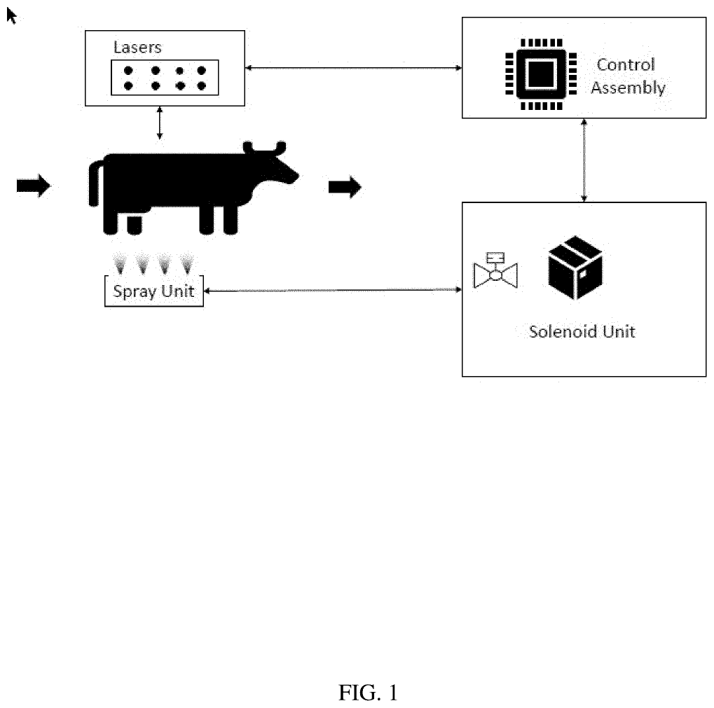

As shown in FIG. 1, the present invention provides a chemical application system comprising a plurality of lasers, a control assembly, a spray unit, and a solenoid unit.

The lasers can be communicatively connected to the spray unit and the control assembly to provide the precise position of the cow moving into the milking parlor. The solenoid unit can be connected to the spray unit to provide air and/or chemicals to allow the system to spray the cow's teats.

The laser can be positioned on or around the milking parlor in a suitable location to provide locational information to the control assembly when a cow is detected to be moving into or out of the milking parlor.

The control assembly may be configured to calculate a desired rate of input of air and chemicals to the spray unit to ensure that the air and the chemicals are transferred in a controlled manner. Air propels the chemical by combining air and product in a chamber on the floor to which nozzles are affixed to. Atomizing and generating foam from the chemical in most cases. Based on the calculation, the control assembly may signal corresponding solenoids to release a desired amount of chemical at a desired rate. The control assembly may also be configured to control other components that can be added to the cleaning system to facilitate a convenient cleaning operation.

The control assembly may be positioned in any suitable location around the milking parlor and may include any suitable logical processing unit embodied as hardware, including but not limited to a processor, a field programmable gate array, a logic circuit, a programmable logic controller (PLC), and the like.

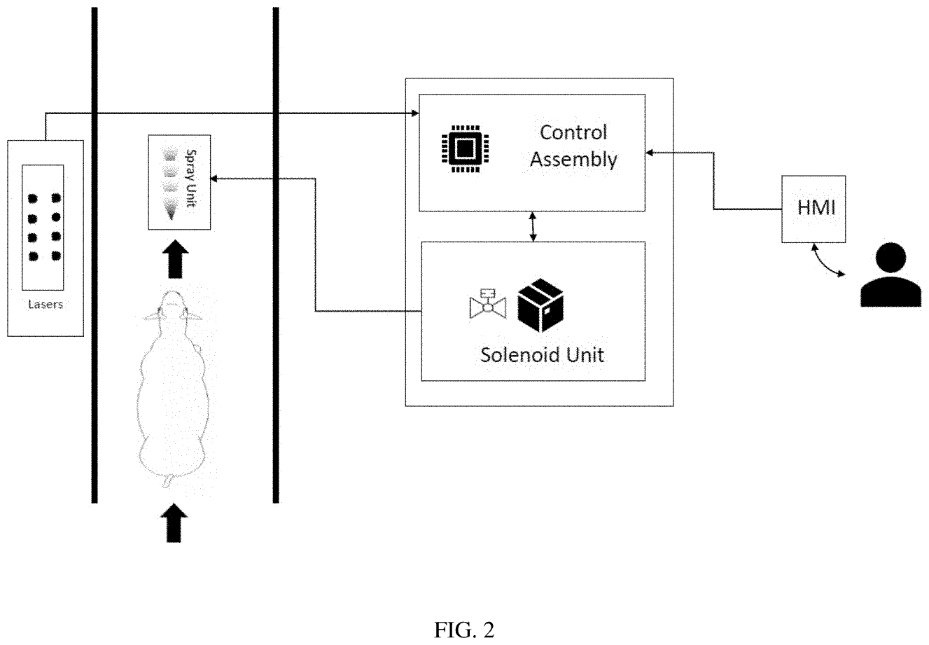

In some embodiments, the control assembly may also include a human-machine interface (HMI) to provide convenient control of the chemical application system, as shown in FIG. 2.

The spray unit may include a plurality of spray nozzles, which can be positioned in a variety of arrangements as long as the droplets of chemicals leaving the spray nozzles are not prevented from reaching the cow's teats.

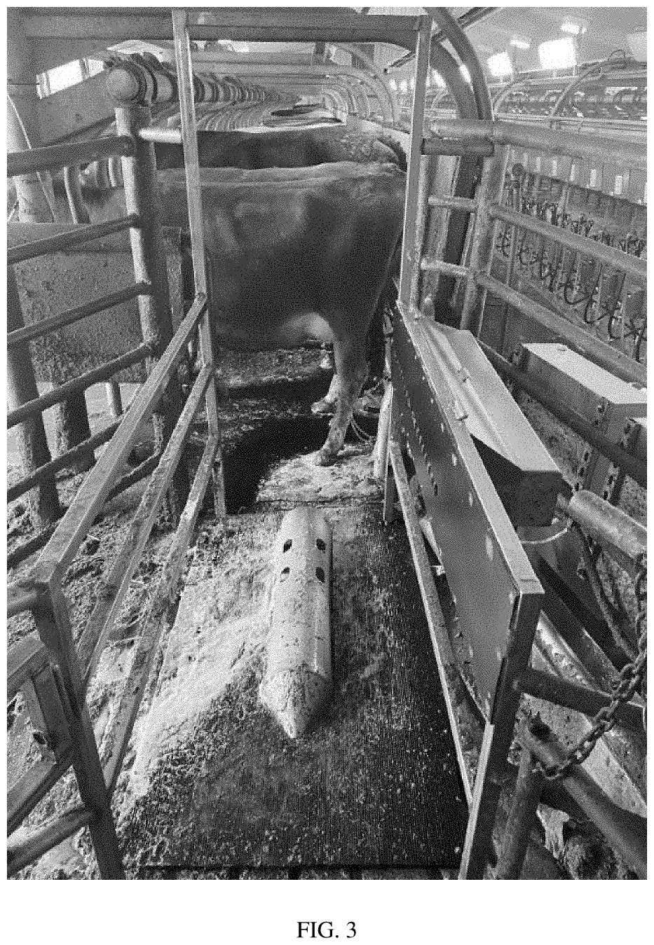

In preferred embodiments, the spray unit is positioned on the ground substantially in the central area of the milking parlor along the direction of its width, as shown in FIG. 3. In some embodiments, the spray unit may include a shield or a cover that can be placed on the ground to protect the spray unit. The spray unit can be of any suitable shape and size to provide thorough cleansing of the teats. In some embodiments, the spray unit can include a longitudinally extended cover (with a length approximately the size of the cow's underside area) with multiple spray nozzles along the length.

The solenoid unit may include a plurality of solenoids and a plurality of containers for air and chemicals. One or more containers with air and cleaning chemicals can be connected to the solenoids to provide air and the chemicals in suitable amounts and rates to the spray unit.

The solenoid unit can be configured to receive signals from the control assembly to control the solenoids. The chemicals can be any suitable disinfecting solution including, but not limited to, iodine, chlorhexidine, chlorine dioxide, hydrogen peroxide, sodium hypochlorite, and quaternary ammonia.

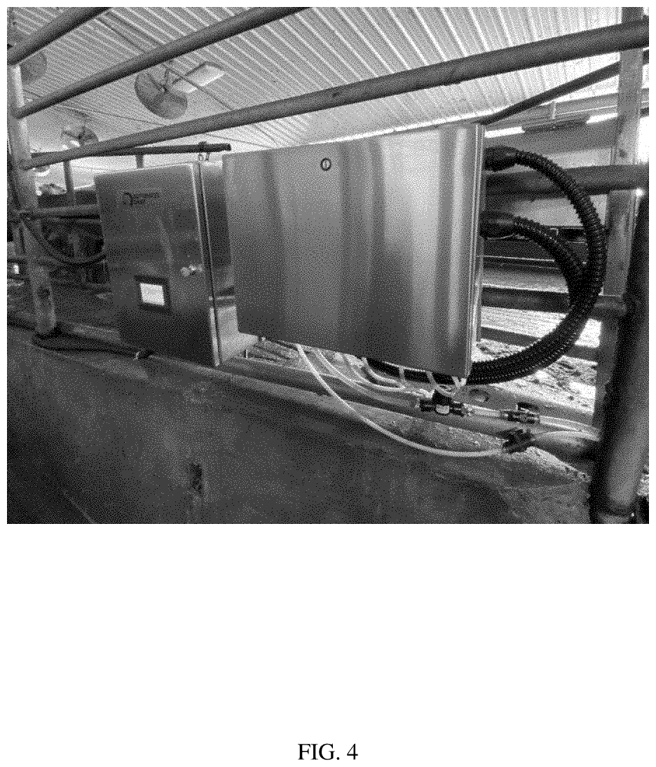

In some embodiments, the cleaning system of the present invention can be used as follows: Allow a cow to walk through the chute with the spray unit installed under a shield on the ground, having also installed at multiple positions in the chute at a cow's waist height above the spray unit so that they detect the position of the cow; lasers send positional information to the PLC, which, when proper conditions are met, activates the solenoids, allowing cleaning chemicals and air to spray from the nozzles on the spray unit for a duration set on the HMI. Lasers are cleaned several times a minute by water jets aimed each laser. Timing for activation of solenoid to turn on water jets is controlled by the PLC. The PLC, HMI, and solenoids can be mounted on a wall near the chute, as shown in FIG. 4.

Communications between components and/or devices in the systems and methods disclosed herein may be unidirectional or bidirectional electronic communication through a wired or wireless configuration or network. For example, one component or device may be wired or networked wirelessly directly or indirectly, through a third-party intermediary, over the Internet, or otherwise with another component or device to enable communication between the components or devices. Communication can be down through Ethernet, IO link, or other communication methods. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

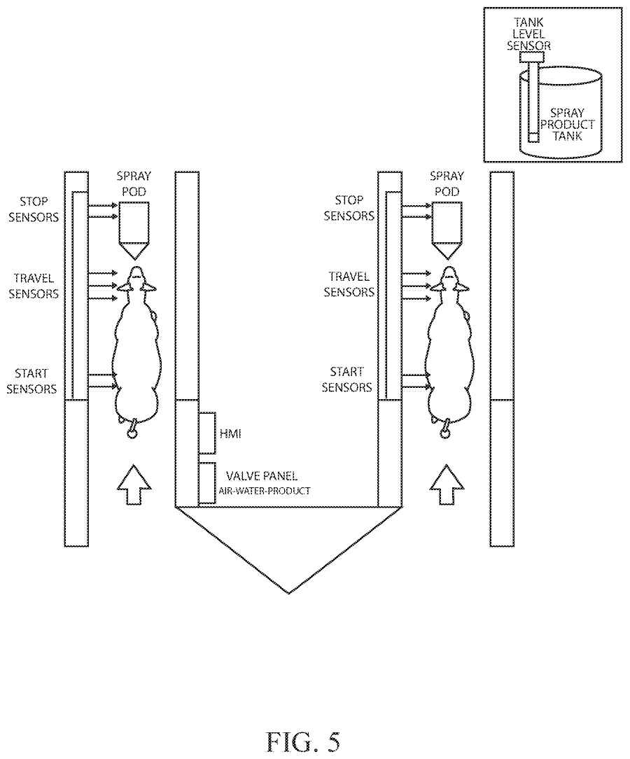

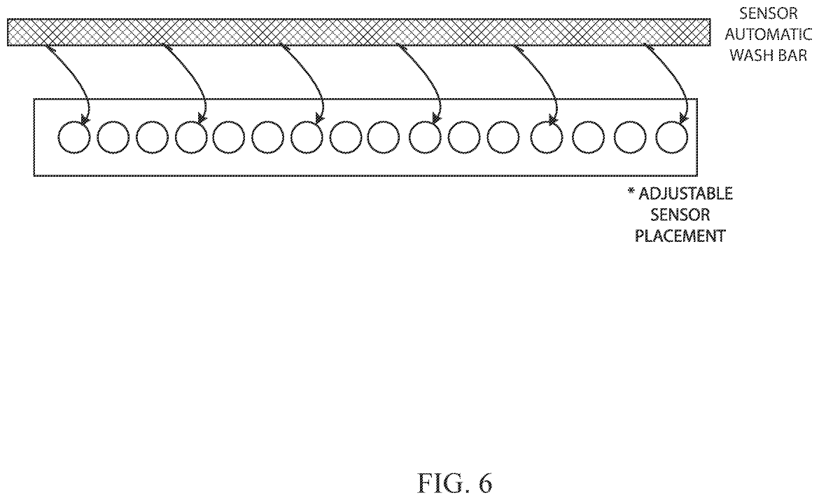

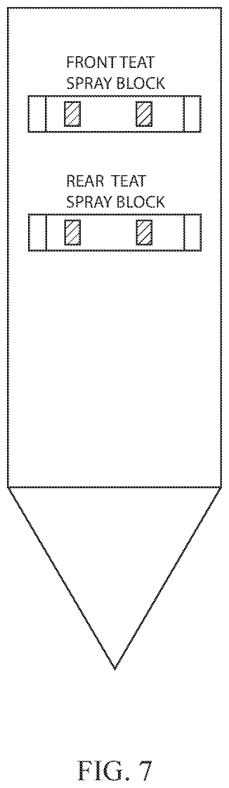

An improved version of the present invention is shown in FIGS. 5, 6, and 7.

Although the invention has been explained in relation to its preferred embodiment, it is to be understood that many other possible modifications and variations can be made without departing from the spirit and scope of the invention.

What is claimed is:

1. An automated cow teat sprayer comprising:
a plurality of lasers;
a control assembly;
a spray unit;
a solenoid unit;
the plurality of lasers being configured to detect a cow moving into or out of a milking parlor;
the plurality of lasers being communicably coupled to the control assembly and the spray unit; and
the solenoid unit being configured to provide a quantity of air and/or a quantity of chemicals to the spray unit.
